(19) United States
(12) Patent Application Publication
(10) Pub. No.: US 2008/0060891 A1
(43) Pub. Date: Mar. 13, 2008

(54) Brake disc structure with composite materials

(75) Inventors: Chih-Yuan Chen, Jinhu Township (TW); Chin-Chuan Huang, Fongshan City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Metal Industries Research & Development Centre, Kaohsiung (TW)

(21) Appl. No.: 11/644,656

(22) Filed: Dec. 22, 2006

(30) Foreign Application Priority Data
Aug. 11, 2006 (TW) 095129696

(51) Int. Cl. F16D 65/12

(52) U.S. Cl. 188/218 XL

(57) ABSTRACT

A brake disc structure with composite materials is provided, which includes a disc-shaped inner disk made of a light metal material, and at least two outer disks respectively stacked and combined with the upper and lower surfaces of the inner disk through a metallurgical reaction process. The outer disks are disc-shaped and made of a ferrous metal material. Moreover, an axle hole is opened in the center of each outer disk for being fitted on a hub and penetrates the inner disk, thereby constituting the brake disc structure of composite materials having properties of abrasion resistance and light weight.

### CROSS-REFERENCE TO RELATED APPLICATIONS

This non-provisional application claims priority under 35 U.S.C. §119(a) on Patent Application No(s). 095129696 filed in Taiwan, R.O.C. on Aug. 11, 2006, the entire contents of which are hereby incorporated by reference.

### BACKGROUND OF THE INVENTION

1. Field of Invention

The present invention relates to a brake disc structure, and more particularly to a brake disc structure having properties of light weight and high abrasion resistance.

2. Related Art

The most important features required of a brake disc are definitely high abrasion resistance and light weight structure. If it is intended to have a property of high structure strength, and can be applied in fields such as racing cars and aircrafts, the brake disc is mainly made of materials such as graphite composite materials, ceramic composite materials to meet the requirements of a high structural strength as well as light weight. However, these materials are usually very expensive, which may increase the cost and make the production insufficient. Hence, for a long time, the graphite composite materials or ceramic composite materials cannot be used to produce brake discs.

In addition, the aluminum alloy having the properties of light weight, high heat conductivity, high corrosion resistance, high abrasion resistance and easy formability can be used to fabricate a brake disc by applying the liquid metal atomization forming technology. In spite of the advantages such as a preferred heat dissipation capability as well as light weight, the aluminum alloy still cannot pass the rigid test on the abrasion resistance of a disc, which has a significant impact on the safety of the brake. Furthermore, some surface modification techniques such as laser surface modification, plasma surface coating, and surface nitridation are used to improve the abrasion resistance of the surface of the aluminum alloy disc, which is advantageous for mass production. However, current tests in the field show that these surface modification techniques still cannot solve the problem of the low abrasion resistance. Thus, it is obvious that a technical bottleneck still exists in the application of light materials such as aluminum alloy in the fabrication of a brake disc.

In another conventional art, a metal matrix composite (MMC) material is provided as a material for brake discs having a high heat dissipation capacity and a high abrasion resistance. The MMC material includes a metal material and ceramic particles added with a volume ratio of 5% to 40%, so as to improve the abrasion resistance of the disc. However, the manufacturing cost of this kind of material is relatively high. Although the brake disc is claimed to have a high heat dissipation capability and a high abrasion resistance, the safety of brake is still not stable due to the unsatisfactory mechanical properties and insufficient abrasion resistance under a high temperature of the material.

Accordingly, the application of either graphite or ceramic composite materials may cause an increase in the overall cost. Besides, no matter the aluminum alloy using an atomization forming technology and even applying a surface modification technology, or adding ceramic particles to fabricate a brake disc, the disadvantage of a low abrasion resistance of the above-mentioned conventional brake discs still exists. Therefore, the present invention is aimed to redesign a structure of the brake disc, so as to decrease the overall weight to make the disc lighter and meanwhile provide a higher abrasion resistance.

### SUMMARY OF THE INVENTION

In view of the above problems in the conventional art, the present invention provides a brake disc structure with composite materials, which is used to meet the requirement of having abrasion resistance, light weight, and low manufacturing cost for a brake disc at the same time.

In order to achieve the above objective, the present invention provides a brake disc structure with composite materials, which comprises an inner disk and at least two outer disks. The inner disk is disc-shaped and made of a light metal material, and the outer disks are respectively stacked on the upper and lower surfaces of the inner disk and respectively combined with the upper and lower surfaces through a metallurgical reaction process. The outer disks are disc-shaped and made of a ferrous metal material, and an axle hole is opened in the center of the outer disks for being fitted on a hub and penetrates the inner disk, thereby constituting the brake disc structure with composite materials having the properties of abrasion resistance and light weight.

The present invention is also directed to provide a brake disc structure with composite materials, which comprises an inner disk and at least two outer disks. The inner disk is disc-shaped and made of a light metal material, and an axle hole is opened in the center of the inner disk for being fitted on a hub. The outer disks are respectively stacked on the upper and lower surfaces of the inner disk and respectively combined with the upper and lower surfaces through a metallurgical reaction process. Moreover, the outer disks are disc-shaped and hollow and are made of a ferrous metal material, thereby constituting the brake disc structure with composite materials having the properties of abrasion resistance and light weight.

The present invention is further directed to provide a brake disc structure with composite materials, which comprises an inner disk, at least two outer disks, and a disk fixing member. The inner disk is disc-shaped and hollow and made of a light metal material, and the outer disks are respectively stacked on an upper surface and a lower surface of the inner disk and respectively combined with the upper and lower surfaces through a metallurgical reaction process. The outer disks are disc-shaped and hollow and are made of a ferrous metal material, and the disk fixing member is engaged with the inner disk through bolting. An axle hole is opened in the center of the disk fixing member for being fitted on a hub, thereby constituting the brake disc structure with composite materials having the properties of abrasion resistance and light weight.

The present invention provides a brake disc structure with composite materials, which has the following advantages superior to the conventional art, and also has the following apparent improvements in efficacy.

1. The present invention provides a brake disc structure with composite materials. The application of the brake disc structure with composite materials of the present invention can reduce the weight more effectively than the conventional brake disc, and have a higher abrasion resistance than the conventional brake disc.

2. The present invention provides a brake disc structure with composite materials. The brake disc structure with composite materials of the present invention is constituted by the composite materials, thus having the abrasion resistance property of the iron-base alloy in the composite materials as well as the properties of a light weight and a high strength of the aluminum alloy or titanium alloy at the same time. Therefore, the brake disc of the present invention has the efficacy improvements of a light weight, a high heat dissipation capability, and an abrasion resistance, as well as a preferred property of the whole material.

In order to make the aforementioned and other objectives, features and advantages of the present invention comprehensible, preferred embodiments accompanied with figures are described in detail below.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIGS. 1A-1B are schematic views of a brake disc structure with composite materials according to a first preferred embodiment of the present invention;

FIGS. 2A-2B are schematic views of a brake disc structure with composite materials according to a second preferred embodiment of the present invention;

FIGS. 3A-3B are schematic views of a brake disc structure with composite materials according to a third preferred embodiment of the present invention; and

FIG. 4 is a schematic view of a brake device having the brake disc and brake main body of the present invention.

### DETAILED DESCRIPTION OF THE INVENTION

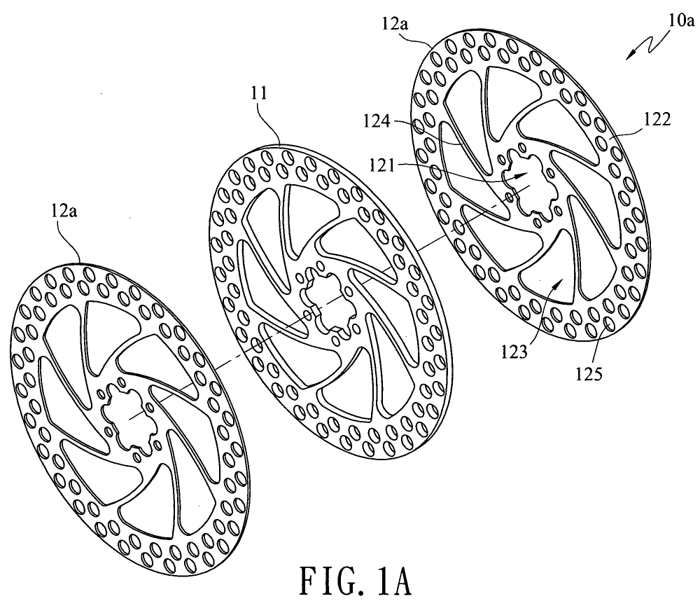

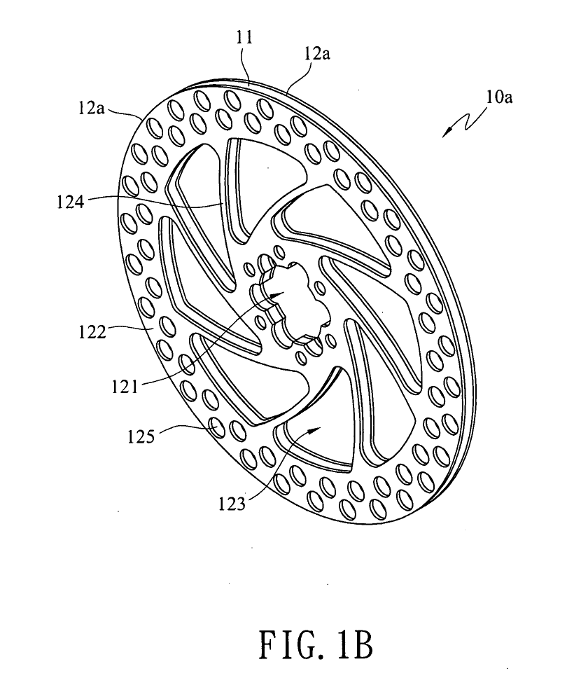

FIGS. 1A and 1B show a first preferred embodiment of a brake disc structure with composite materials according to the present invention. The brake disc structure with composite materials 10a includes an inner disk 11 and at least two outer disks 12a. The inner disk 11 is disc-shaped and made of a light metal material, wherein the light metal material has a specific gravity less than 4 g/cm³ and is a material such as aluminum alloy or titanium alloy. The outer disks 12a are respectively stacked on an upper surface and a lower surface of the inner disk 11 and combined with the upper and lower surfaces of the inner disk 11 through a metallurgical reaction process. The above outer disks 12a are disc-shaped and made of a ferrous metal material, wherein the ferrous metal material is a cast iron material or a stainless steel material. An axle hole 121 is opened in the center of the outer disk 12a for being fitted on a hub and penetrates the inner disk 11, thereby constituting the brake disc structure with composite materials 10a having the properties of abrasion resistance and light weight. The above-mentioned metallurgical reaction process is a rolling method, a lamination method, or a diffusion method.

In addition, the peripheries of the above-mentioned outer disks 12a are respectively provided with a disk brake surface 122. A plurality of stripping holes 123 is opened in the space sandwiched between the disc brake surface 122 and the axle hole 121, and penetrates the inner disk 11. A rib 124 is formed between the adjacent stripping holes 123. Further, a plurality of heat dissipation holes 125 is formed in the disc brake surface 122 of each outer disk 12a, and penetrates the inner disk 11, so as to exhaust the heat produced during the brake rapidly.

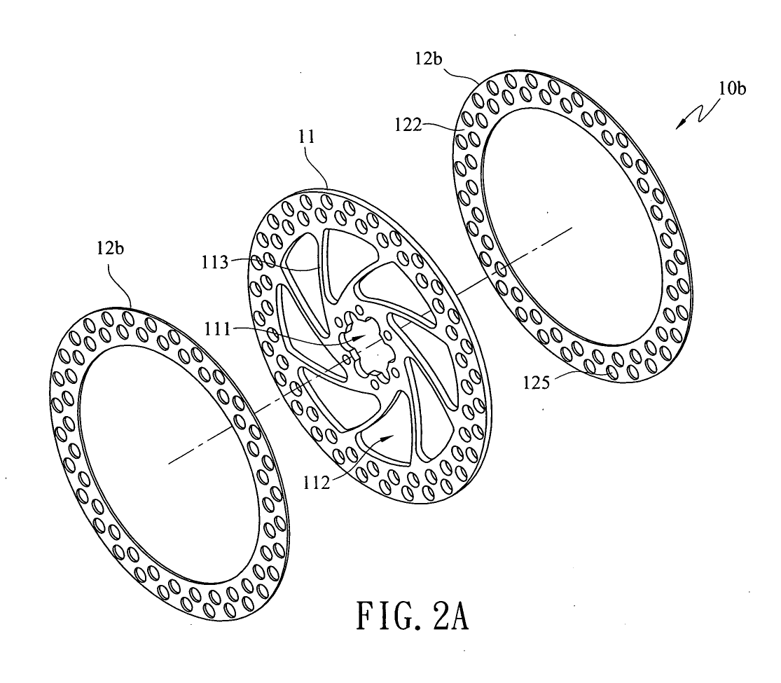

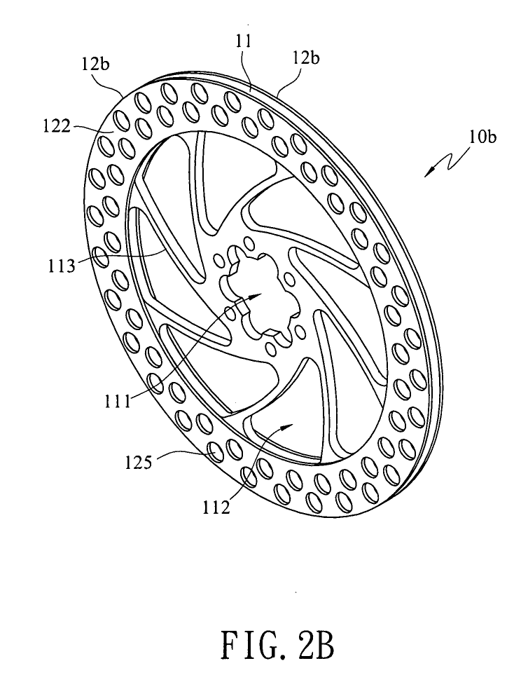

FIGS. 2A and 2B show a second preferred embodiment of the brake disc structure with composite materials according to the present invention. The brake disc structure with composite materials 10b includes an inner disk 11 and at least two outer disks 12b. The inner disk 11 is disc-shaped and is made of a light metal material, wherein the light metal material has a specific gravity less than 4 g/cm³ and is a material such as aluminum alloy or titanium alloy. An axle hole 111 is opened in the center of the inner disk 11 for being fitted on a hub, and the outer disks 12b are respectively stacked on an upper surface and a lower surface of the inner disk 11 and respectively combined with the upper and lower surfaces of the inner disk 11 through a metallurgical reaction process. The outer disks 12b are disc-shaped and hollow, and are made of a ferrous metal material, wherein the ferrous metal material is a cast iron material or a stainless steel material, thereby constituting the brake disc structure with composite materials having the properties of abrasion resistance and light weight. The above-mentioned metallurgical reaction process is a rolling method, a lamination method, or a diffusion method.

Moreover, the peripheries of the above-mentioned outer disks 12b are respectively provided with a disk brake surface 122, and a plurality of stripping holes 112 is opened in the inner disk 11 in the space sandwiched between the outer disks 12b and the axle hole 111. A rib 113 is formed between the adjacent stripping holes 112. Further, a plurality of heat dissipation holes 125 is formed in the disc brake surface 122 of each outer disk 12b and penetrates the inner disk 11, so as to exhaust the heat produced during the brake rapidly.

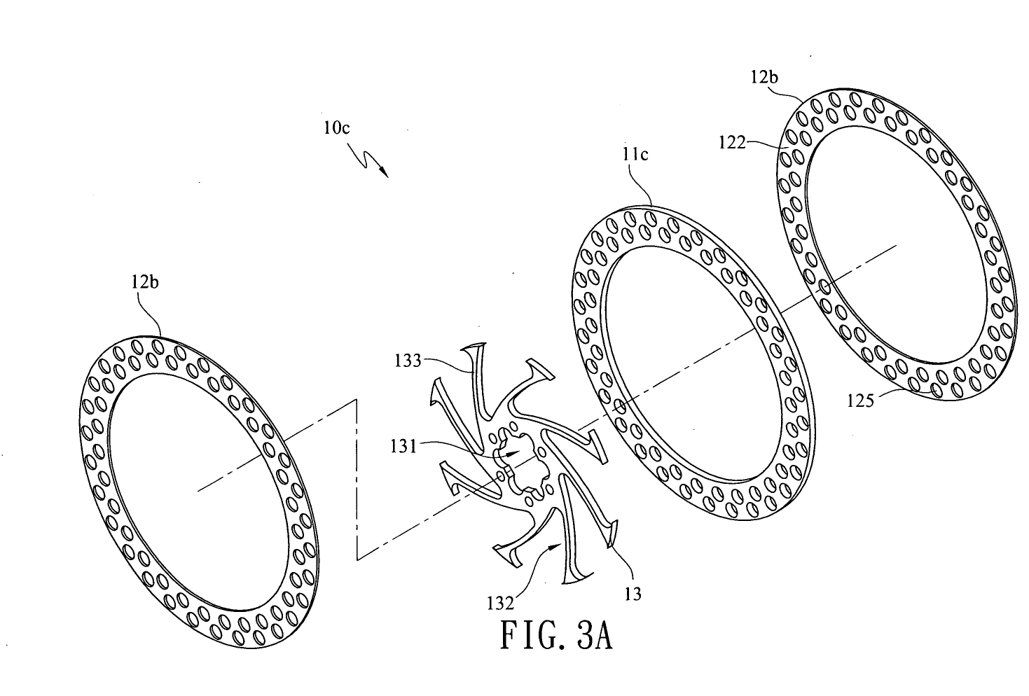

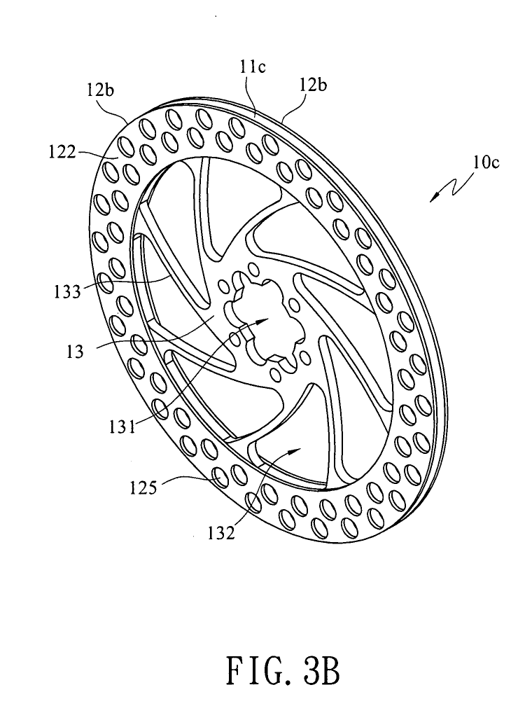

Furthermore, FIGS. 3A and 3B show a third preferred embodiment of the brake disc structure of composite materials according to the present invention. The brake disc structure of composite materials 10c includes an inner disk 11c, at least two outer disks 12b, and a disk fixing member 13. The inner disk 11c is disc-shaped and hollow and made of a light metal material, wherein the light metal material has a specific gravity less than 4 g/cm³ and is a material such as aluminum alloy or titanium alloy. The outer disks 12b are respectively stacked on an upper surface and a lower surface of the inner disk 11c and respectively combined with the upper and lower surfaces of the inner disk 11c through a metallurgical reaction process. The outer disks 12b are disc-shaped and hollow, and are made of a ferrous metal material, wherein the ferrous metal material is a cast iron material or a stainless steel material. The above disk fixing member 13 is engaged with the inner disk 11c through bolting. An axle hole 131 is opened in the center of the disk fixing member 13 for being fitted on a hub, and the disk fixing member 13 is made of a light metal material or a ferrous metal material, wherein the light metal material such as an aluminum alloy or a titanium alloy has a specific gravity less than 4 g/cm³, and the ferrous metal material is a cast iron material or a stainless steel material, thereby constituting the brake disc structure with composite materials 10c having the properties of abrasion resistance and light weight. The above-mentioned metallurgical reaction process is a rolling method, a lamination method, or a diffusion method.

In addition, the above-mentioned outer disks 12b are respectively provided with a disk brake surface 122. A plurality of stripping holes 132 is opened in the disc fixing member 13 in the space sandwiched between the axis hole 131 of the disk fixing member 13 and the inner disk 11c. A rib 133 is formed between adjacent stripping holes 132. Besides, a plurality of heat dissipation holes 125 is formed in the disc brake surface 122 of the outer disks 12b and penetrates the inner disk 11c, so as to exhaust the heat produced during the brake rapidly.

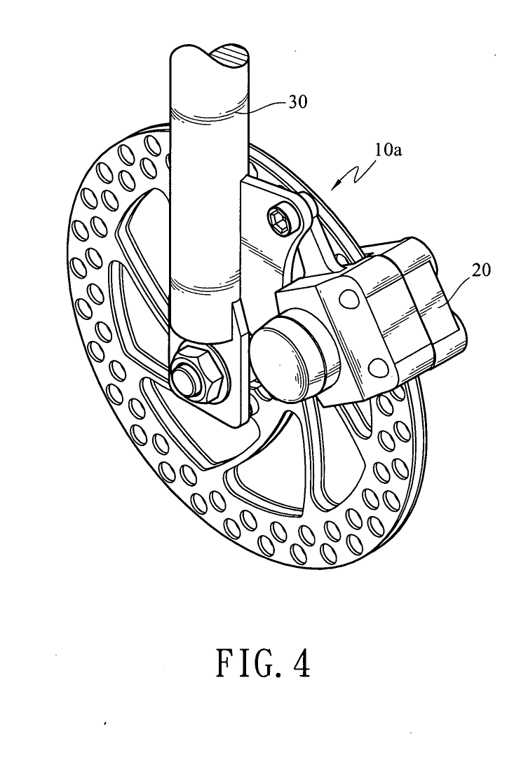

Referring to FIG. 4, when the brake disc structure with composite materials 10a is used together with a brake main body 20 and locked to a fork 30 of a vehicle to form a brake device, the brake main body 20 is used to grip the brake disc, so as to slow down or stop the vehicle. Likewise, the brake disc structures with composite materials 10b and 10c of the present invention are also used to slow down or stop a vehicle, and the brake disc structures with composite materials 10a, 10b, and 10c of the present invention are also adapted for a brake disc of a bicycle.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A brake disc structure with composite materials, comprising:
an inner disk, being disc-shaped and made of a light metal material; and
at least two outer disks, respectively stacked on an upper surface and a lower surface of the inner disk, and respectively combined with the upper and lower surfaces of the inner disk through a metallurgical reaction process, wherein the outer disks are disc-shaped and are made of a ferrous metal material, and an axle hole is opened in the center of the outer disks for being fitted on a hub and penetrates the inner disk;
thereby constituting the brake disc structure with composite materials having the properties of abrasion resistance and light weight.

2. The brake disc structure with composite materials as claimed in claim 1, wherein the peripheries of the outer disks are respectively provided with a disk brake surface; a plurality of stripping holes is opened in the space sandwiched between the disc brake surface and the axle hole and penetrates the inner disk; and a rib is formed between the adjacent stripping holes.

3. The brake disc structure with composite materials as claimed in claim 1, wherein a plurality of heat dissipation holes is formed in the disc brake surface of each outer disk and penetrates the inner disk.

4. The brake disc structure with composite materials as claimed in claim 1, wherein the metallurgical reaction process is a rolling method, a lamination method, or a diffusion method.

5. The brake disc structure with composite materials as claimed in claim 1, wherein the light metal material of the inner disk is an aluminum alloy material or a titanium alloy material.

6. The brake disc structure with composite materials as claimed in claim 1, wherein the ferrous metal material of the outer disks is a cast iron material or stainless steel material.

7. A brake disc structure with composite materials, comprising:
an inner disk, being disc-shaped and made of a light metal material, wherein an axle hole is opened in the center of the inner disk for being fitted on a hub; and
at least two outer disks, respectively stacked on an upper surface and a lower surface of the inner disk, and respectively combined with the upper surface and the lower surface of the inner disk through a metallurgical reaction process, wherein the outer disks are disc-shaped and hollow and are made of a ferrous metal material;
thereby, constituting the brake disc structure of composite materials having the properties of abrasion resistance and light weight.

8. The brake disc structure with composite materials as claimed in claim 7, wherein the outer disks are respectively provided with a disk brake surface; a plurality of stripping holes is opened in the inner disk in the space sandwiched between the outer disks and the axle hole of the inner disk; and a rib is formed between the adjacent stripping holes.

9. The brake disc structure with composite materials as claimed in claim 7, wherein a plurality of heat dissipation holes is formed in the disc brake surface of each outer disk and penetrates the inner disk.

10. The brake disc structure with composite materials as claimed in claim 7, wherein the metallurgical reaction process is a rolling method, a lamination method, or a diffusion method.

11. The brake disc structure with composite materials as claimed in claim 7, wherein the light metal material of the inner disk is an aluminum alloy material or a titanium alloy material.

12. The brake disc structure with composite materials as claimed in claim 7, wherein the ferrous metal material of the outer disks is a cast iron material or a stainless steel material.

13. A brake disc structure with composite materials, comprising:
an inner disk, being disc-shaped and hollow and made of a light metal material;
at least two outer disks, respectively stacked on an upper surface and a lower surface of the inner disk, and respectively combined with the upper and lower surface of the inner disk through a metallurgical reaction process, wherein the outer disks are disc-shaped and hollow and are made of a ferrous metal material; and
a disk fixing member, engaged with the inner disk through bolting, wherein an axle hole is opened in the center of the disk fixing member for being fitted on a hub;
thereby constituting the brake disc structure of composite materials having the properties of abrasion resistance and light weight.

14. The brake disc structure with composite materials as claimed in claim 13, wherein the outer disks are respectively provided with a disk brake surface; a plurality of stripping holes is opened in the disk fixing member in the space sandwiched between the axle hole of the disk fixing member and the inner disk; and a rib is formed between the adjacent stripping holes.

15. The brake disc structure with composite materials as claimed in claim 13, wherein a plurality of heat dissipation holes is formed in the disc brake surface of each outer disk and penetrates the inner disk.

16. The brake disc structure with composite materials as claimed in claim 13, wherein the metallurgical reaction process is a rolling method, a lamination method, or a diffusion method.

17. The brake disc structure with composite materials as claimed in claim 13, wherein the light metal material of the inner disk is an aluminum alloy material or a titanium alloy material.

18. The brake disc structure with composite materials as claimed in claim 13, wherein the ferrous metal material of the outer disks is a cast iron material or a stainless steel material.

19. The brake disc structure with composite materials as claimed in claim 13, wherein the disk fixing member is made of a light metal material or a ferrous metal material.

20. The brake disc structure with composite materials as claimed in claim 19, wherein the light metal material is an aluminum alloy material or a titanium alloy material.

21. The brake disc structure with composite materials as claimed in claim 19, wherein the ferrous metal material is a cast iron material or a stainless steel material.
